(19) United States
(12) Patent Application Publication
(10) Pub. No.: US 2026/0221320 A1
(43) Pub. Date: Jul. 30, 2026

(54) DEVICE AND METHOD FOR PRODUCING A CABLE HARNESS

(71) Applicant: KOMAX HOLDING AG, Dierikon (CH)

(72) Inventors: Heinz Billing, Haunetal Wehrda (DE); Adrian Muther, Eschenbach (CH); Markus Meyer, Hergiswil (CH)

(21) Appl. No.: 19/137,422

(22) PCT Filed: Dec. 14, 2023
(86) PCT No.: PCT/EP2023/085871

§ 371 Date: Jun. 10, 2025

(30) Foreign Application Priority Data
Dec. 15, 2022 (EP) 22213861.2

(51) Int. Cl. H01B 13/012

(52) U.S. Cl. CPC H01B 13/01245

(57) ABSTRACT

A device for producing a cable harness includes a vertical presentation plate on which cables of the cable harness are arranged on a front side of the presentation plate, and handling elements for handling the cables of the cable harness, wherein the handling elements are magnetically attached to the presentation plate. The handling elements can be moved in all directions of the plane defined by the presentation plate by a gantry robot. The presentation plate is made of a non-ferromagnetic material. The handling elements each comprise a front-side handling part and a rear-side moving part, wherein one of the parts is equipped with a permanent magnet and another part is also equipped with a permanent magnet so that the permanent magnets attract each other.

### FIELD

The invention relates to a device and method for producing a cable harness.

### BACKGROUND

Cable harnesses such as those used in automobiles or aircraft, for example, consist of a plurality of cables, wherein the cables are each generally provided with plug housings at their prefabricated cable ends. A cable harness is an arrangement of a plurality of cables in which the cables are assembled into a structure with an often complex, branched geometry similar to a tree.

When producing a cable harness, certain locations and areas of the cable harness must be secured. For example in so doing, branches and nodes can be secured using suitable tools (for example spot tapes or cable ties). It may also be necessary to provide additional protection for the cable harness as a whole or in regions (e.g. by taping it with adhesive tape). Furthermore, it may be necessary at defined locations to equip the cable harness with mounting elements such as clips in order to be able to ultimately install the cable harness in an apparatus intended for it, such as an automobile. The aforementioned processing of the cable harness is also known to a person skilled in the art as “forming” or “fixing”, since the tree-like structure is created from the plurality of individual cables.

Conventionally, these processing steps are carried out on a laying board by hand or with appropriate electric hand tools. In so doing, the entire cable harness is stretched on the laying board. In particular, workers must remove the nodes of the cable harness from the forked brackets of the laying board in order to work on the areas correctly.

Recently, there have been efforts towards automation. A method and a corresponding device have become known, for example, from EP 2 706 725 B1. Here the approach disclosed is to stretch the cable harness along a straight line so that the nodes can be secured. The positions must be processed one after the other. Another approach for producing a cable harness is disclosed in EP 673 091 A2. The approach here substantially consists of first completely stretching the cable harness on the laying board, similar to manual work, and then carrying out the work steps using processing robots. What both approaches have in common is the comparatively large space requirement, i.e., the problem that the respective devices according to the prior art are relatively large or long. A further disadvantage is that the production performance of the devices is insufficient in practice. The approach of stretching along a straight line is only partially suitable for parallelizing the processing steps, which clearly limits the production output.

### SUMMARY

It is therefore an object of the present invention to overcome the disadvantages of what is known, and in particular to create an improved device for producing a cable harness which in particular can be operated efficiently.

According to the invention, this object is achieved by a device having the features described herein. The device for producing a cable harness comprises a preferably vertical presentation plate on which cables of the cable harness of the presentation plate can be arranged, and handling elements for handling the cables of the cable harness. The handling elements are in this case in particular magnetically attached or attachable to the presentation plate and are designed such that they can be moved preferably freely in all directions of the plane defined by the presentation plate. The purpose of the presentation plate is inter alia to present cables or cable harnesses of the cable harness on this plate so that the cables or cable harnesses can be secured or taped manually or mechanically at the designated locations with securing devices such as spot tapes. A handling element is understood below to mean an element with which a single cable or a plurality of cables are handled so that it or they can be processed with a view to producing the cable harness. One such processing is, for example, securing certain points and regions of the cable harness using suitable tools (e.g. spot tapes, cable ties).

Alternatively or in addition to the above-mentioned preferably vertical presentation plate, a presentation plate with a different orientation can also be considered for the device according to the invention. The presentation plate could be a slanted presentation plate or one inclined at an angle to the horizontal. Steep presentation plates that are approximately vertical (e.g., angle of inclination >80°) can be considered as substantially vertical presentation plates. For certain applications, it would even be conceivable for the device to have a horizontal presentation plate.

Permanent magnets can be used to magnetically attach the handling elements to the preferably vertical presentation plate, with the help of which the handling elements can be held securely in the desired position on the presentation plate. Thanks to such magnets, the handling elements are attached to the presentation plate in an adhesive but still movable manner. Preferably, permanent magnets are chosen that are only strong enough to allow the handling elements to be detached from the presentation plate so that handling elements can be easily replaced by hand if necessary. As an alternative to magnetic attachment, the adhesion of the handling elements to the preferably vertical presentation plate could also be achieved in other ways, for example by using means for generating a vacuum or by means of a hook-and-loop connection.

Permanent magnets have the advantage that they ensure reliable operation in a simple manner and remain in the current position on the presentation plate, in particular in the event of a fault (e.g., in the event of an unexpected power failure due to a mains outage). As an alternative to the handling elements being attached or attachable to the presentation plate magnetically or using vacuum or other adhesive or holding means, other designs are also conceivable. For example, the handling elements could be connected to the presentation plate using at least one planar motor in such a way that the handling elements can be moved in all directions of the plane defined by the presentation plate.

In a particularly preferred embodiment, the aforementioned preferably vertical presentation plate, on which cables of the cable harness can be arranged on a front side of the presentation plate, can consist of a non-ferromagnetic material. The handling elements or the respective handling elements can each comprise a front-side handling part and a rear-side moving part. The front-side handling part is thus assigned to the front side of the presentation plate and the rear-side moving part is assigned to the rear side of the presentation plate opposite the front side. In other words, the handling part and the moving part are mounted on opposite sides (front side, rear side) of the presentation plate. The front-side handling part and the associated rear-side moving part form a two-part handling element combined into a common assembly. By moving the moving part on the presentation plate, the handling part can be entrained. The handling part and the associated rear-side moving part, i.e., the parts of the assembly, are separated from each other by the presentation plate, but are operatively connected to each other (e.g., by magnetic force).

Here, at least one of the parts (i.e., handling part, moving part) of the respective handling element is equipped with a permanent magnet for magnetic attachment to the presentation plate, wherein the other part contains ferromagnetic material, or the other part is also equipped with a permanent magnet but with an unlike pole, so that the permanent magnets attract each other (handling part and moving part therefore roughly correspond to: 1 permanent magnet and 1 ferromagnetic material; or 2 permanent magnets with unlike poles so that the permanent magnets attract each other). The latter case with the two permanent magnets is to be understood as meaning that the permanent magnets are arranged and oriented relative to each other in such a way that unlike poles are opposite each other so that the permanent magnets attract each other.

If, as described above, the parts (handling part, moving part) of the handling element are magnetically attached to the presentation plate, the handling part can be entrained by moving the moving part on the presentation plate. The handling part is thus moved indirectly. This has the advantage, among other things, that the side of the presentation plate assigned to the cable harness, which corresponds to the side on which the handling parts are arranged, can be free of means for movement, which has a positive effect on the handling of the cables and the cable harness.

According to this preferred embodiment, at least one of the parts (i.e., handling part, moving part) of the respective handling element is equipped with a permanent magnet for magnetic attachment to the presentation plate. This does not mean that the respective part only has to be equipped with a permanent magnet for magnetic attachment to the presentation plate. For certain applications and with a view to carrying out precise movements, it can be helpful if each part (handling part, moving part) of the handling elements has at least two and preferably four permanent magnets. Thus, for example, four pairs of magnets can be installed in one handling element, i.e., four permanent magnets in the handling part and four permanent magnets in the moving part. This arrangement has the further advantage that, if necessary, the handling element can be rotated from the rear side around its axis (rotation axis is coplanar to the normal direction of the presentation plate).

Such a two-part handling element with a front-side handling part and a rear-side moving part can be easily and reliably attached to the presentation plate and can be precisely brought into the desired position on the presentation plate. The handling part on the front side with reference to the presentation plate, facing the cable harness, is used for the actual handling of individual parts of the cable harness and comprises means with which cables, for example in the form of cable bundles, prefabricated cable ends equipped with connector housings, branches, etc., can be grasped, held together or otherwise handled. The moving part at the back with reference to the presentation plate is used to move the handling element. In other words, the handling element can be moved manually or mechanically via the moving part. While moving the moving part on the presentation plate, the handling part is moved congruently.

The moving part can have a coupling part connected to a main body, via which coupling part the handling element can be moved. The main body is the part of the handling element that is in contact with the presentation plate. The permanent magnet is preferably integrated in the main body. However, the main body could also consist of or contain ferromagnetic material. The coupling part forms, in a sense, the interface to the unit via which the moving part can be driven for the movement of the handling element. This unit can be a positioning system with a coupling part, via which coupling part the handling element can be coupled via its coupling part, and thus the required operative connection between the positioning system and the handling element for the movement can be created. In the case of manual operation, the coupling part could also be a handle which the operator can grasp with his hand and thus move the handling element manually.

The handling part can have a handling head connected to a main body and a handling head connected to a main body. The main body of the handling part can be designed approximately the same as the main body of the moving part, in particular with regard to its dimensions and in particular with regard to its base area.

For easy handling, it may be advantageous if the handling part has a handling head connected to the main body, which handling head is connected to the main body so that it can rotate freely with respect to the normal direction.

Particularly advantageously, the handling head is designed in such a way that, when the handling element is mounted on the vertical presentation plate, the handling head remains in its vertically aligned basic position due to gravity. In the basic position, the handling head is oriented in a vertical direction, which can be easily achieved by appropriate weight distribution in the handling head. Thanks to the automatically correct alignment, no complex adjustments of the rotation angle of the handling head are required. Of course, not every one of the numerous handling elements has to include handling heads that can be freely rotated and automatically aligned in a basic position.

At least some of the handling elements of the device for producing a cable harness can be designed as housing holders for holding housings. The respective housing holder can temporarily hold a single or, in some cases, even several housings for the production of the cable harness. A housing, the purpose of which is to create electrical plug-in connections in particular, or more precisely the prefabricated cable end provided with the housing, can be moved into the desired position on the presentation plate thanks to the housing holder. The housing holder can comprise a housing receptacle into which the housing(s) can be inserted for secure holding, or other means for temporarily holding the housing. The housing holder is assigned to the handling head of the housing holder.

At least some of the handling elements of the device for producing a cable harness can be designed as deflectors for deflecting the course of cables. If the housing holders are seen as the first type of handling elements, the deflectors for deflecting the course of cables of the cable harness (one or, if necessary, a plurality of cables can be deflected, wherein in the case of a plurality of cables the cables are usually present as a loose or already secured cable bundle) form a second type of handling elements. For example, deflectors are usually used to bend individual cables at defined positions, for example at branches, in the branched structure of the cable harness.

The handling head of the deflector can have an open hook which preferably has a V-shape in a side view. It is advantageous if the handling head of the deflector comprises a guide element arranged on the hook, in particular in the region of its apex, and in particular a guide rod. The hook and the guide element can form a horizontal “K” in the side view.

At least some of the handling elements of the device for producing a cable harness can be designed as a hold-up means. The hold-up means form a third type of handling elements. Hold-up means are used to hold up individual cables or a plurality of cables combined in the form of a cable harness and thus increase the distance to the presentation plate in order to enable cables to be passed under the aforementioned individual cable or cables held up. By means of one and preferably two hold-up means, for example, a main strand of the cable harness can be held in a portion further away from the positioning plate, whereby an enlarged gap arises below the cable harness held up in this way so that other parts of the cable harness can be guided underneath without obstruction, for example by means of a housing holder, thereby enabling further branching on two sides.

The handling head of the hold-up means can comprise a flank section running obliquely and in particular at 45° to the horizontal and a cable receiving section adjoining the flank section and preferably U-shaped in side view.

The presentation plate according to a further embodiment of the device can have at least one parking zone, preferably arranged at the edge, with a plurality of parking bays arranged next to one another for parking individual handling elements. Thanks to the parking zones, optimal organization and control of the many handling elements is ensured. If the preferably vertical presentation plate defines a rectangular shape with two horizontal rectangular sides and two vertical rectangular sides, one of the rectangular sides and preferably the upper horizontal rectangular side and one of the vertical rectangular sides can have such parking zones. This arrangement has further advantages in terms of automation.

If the main body has a base area that is preferably circular in cross section, it can be advantageous if the parking bays and preferably each parking bay each have a receptacle for the main body that is formed by an indentation and in particular a receptacle complementary to the main body and preferably forming a circular arc, as a result of which the respective handling element is located or can be brought precisely into the parking position. The parking bays having receptacles can preferably be arranged on the rear side of the presentation plate.

The device can have a positioning system for moving the handling elements into the desired position, which positioning system is preferably integrated in the presentation plate, wherein the positioning system is formed in particular by a gantry robot. Using gantry robots, the handling elements can be moved quickly and precisely into the desired position, wherein, depending on requirements, even complicated paths can be easily covered when moving using the gantry robot. As an alternative to the gantry robot, delta robots or other types of positioning robots or positioning systems are also conceivable.

The positioning system and in particular the gantry robot can have a positioning head, via which positioning head a handling element can be acted upon and moved. For this purpose, the positioning head can have a coupling part which can be brought into operative connection (i.e., coupled) with the coupling part assigned to the handling element as described above, so that the movement of the positioning head can then be transferred to the handling element.

For the joint movement of a plurality of handling elements, the positioning system can have a positioning head with a plurality of coupling parts, via which the positioning system can be brought into operative connection with a plurality of handling elements. These multiple coupling parts can be rigidly connected to each other. However, it can be advantageous if the multiple coupling parts can be moved separately relative to each other at least in relation to the plane of the presentation plate, which enables even more complex movements.

For example, the positioning head can be designed such that the plurality of coupling parts are arranged next to one another in a row, at a distance from one another, which distance can be changed by means of an adjustment mechanism, and/or that the plurality of coupling parts are pivotally connected to one another.

According to a further embodiment, the device can have two presentation plates. In this case, between the two presentation plates, at least one processing robot can be provided, with the aid of which securing means can be attached to the cables for fixing and securing at points or sections. The at least one processing robot can be responsible for two presentation plates. Preferably, at least two processing robots and particularly preferably at least three processing robots are provided.

In a further embodiment, it is also conceivable to reserve a separate area of the presentation plate for a manual workstation. At this manual workstation, for example, grommets can be attached to the cable harness. In this case, the positioning system also presents the relevant cable harness area, as for the processing robot(s).

The invention then relates to a method for producing a cable harness, preferably using the device described above. The following steps are carried out in this method:
providing a vertical presentation plate;
arranging cables equipped with housings required for the cable harness on the presentation plate using housing holders, wherein the housing holders are arranged in a predetermined order in the horizontal direction (starting position);
inserting deflectors between the housing holders, wherein the housing holders may first be moved in such a way that the distance between the housing holders is increased;
moving a portion of the housing holders from the housing holder row, preferably moving upward those housing holders which are assigned to the upper branches of the cable harness; and
attaching securing means from the group of spot tapes, clips or bandages for fixing and securing upwardly moved cables at points or sections by means of at least one processing robot.

Before the above-mentioned arrangement of the cables on the presentation plate, the method may also include the following method steps:
providing or preparing a technical drawing for the cable harness;
the cables are assembled based on the technical drawing. Cables can be unwound from a cable storage unit, cut to length in a cable processing machine, stripped and, if necessary, crimped, and fitted with housings in a housing assembly machine.

The arrangement of prefabricated cables equipped with housings required for the cable harness on the presentation plate is preferably carried out using housing holders freely movable on the vertical presentation plate, wherein the housing holders and thus also the housings are lined up in the predetermined order by means of a positioning system in the horizontal direction at a horizontal starting height, and wherein after completion of the arrangement, the cables are each present in a U-shape hanging downward. After arranging, the cables are located on the presentation plate using housing holders, with the housing holders in the aforementioned initial position. In other words, in the initial position, a rough form of the cable harness is brought into an overall U-shape with a large number of cables hanging downward in a U-shape, forming cable loops.

The initial arrangement can be carried out in such a way that afterward, the housing holders are then arranged in a compact starting position as close to each other as possible in the row. For example, even in the form of a longitudinal block with housing holders contacting each other.

Before retracting deflectors between the housing holders, the following additional work step may be necessary:
moving the housing holders in such a way that the distance between the housing holders is increased (pulled apart) in order to enable deflectors—where necessary—to be inserted smoothly between the housing holders from top to bottom.

For inserting deflectors between the housing holders, freely movable deflectors can be used, preferably on the presentation plate.

In a preferred embodiment, the securing means are attached step by step, wherein between the steps, a housing holder and, if applicable, deflectors are brought into positions by appropriate movement, which includes movement components in the horizontal direction, so that cables are optimally positioned. When moving the housing holders, it may be advantageous to carry out the movement as a lateral drag.

Preferably, the housing holders that are assigned to lower branches of the cable harness are only moved downward after the cable harness has been completed with respect to the upper branches.

According to an advantageous method, cables are lifted by means of lifting jacks so that housing holders can move downward under the thus lifted cable to create lower branches.

When a cable harness is manufactured with branches oriented upward and downward relative to a main strand, it is advantageous to arrange the cables on the presentation plate in such a way that the lower branches are in the minority compared to the upper branches, with regard to the finished cable harness. This arrangement can ensure that as few underpasses as possible have to be made using hold-up means, making the method considerably faster and easier to carry out.

A further embodiment of the method relates to determining the sequence of the housing holders arranged in a row. This order is determined by the following factors:
Housing holders and thus the housings held by them, which are assigned to upwardly oriented branches of the cable harness, are positioned in the middle of the row;
Housing holders and thus the housings held by them, which are assigned to the main strand of the cable harness, are positioned outside the row;
Housing holders and thus the housings held by them, which are assigned to downwardly oriented branches of the cable harness, are added further out in the row, wherein the latter housing holders assigned to the downwardly oriented branches are generally positioned further out than the previous housing holders assigned to the main strand. According to these factors, the following sequence can ideally result for a cable harness with four upper branches O and five lower branches U (H: main branch): UUUHOOOOHUU.

When positioning the housing holders, the respective cable lengths of the cables are taken into account, wherein housing holders or the housings held by them, which are each assigned to common cables with short cable lengths, are preferably positioned directly next to each other. Depending on the cable lengths, different sequences may result than in the order given above, which represents the ideal case, such as UUHOOOUOHUU.

With housing holders arranged in such a sequence, the cable harness can be produced in an efficient and effective manner. The movements of handling elements can be carried out quickly and reliably. Another advantage is that cable overload and possible cable damage can be prevented.

Furthermore, when determining the order, it can be advantageous to also take into account the cable lengths of cables and downward-oriented branches. If these cable lengths are too short, in order to provide sufficient clearance for the subsequent positioning movements, the housing holders and thus the housings held by them, which are assigned to such branches downward, are arranged between those upward following the main strand.

In another embodiment, the downward branches may be moved earlier between the upward branches, in particular when there is a very short wire connection or cable length between a branch pointing downward and one pointing upward (e.g., in the unwound state, they are located exactly on top of each other).

### DESCRIPTION OF THE DRAWINGS

Further individual features and advantages of the invention emerge from the following description of exemplary embodiments and from the drawings. In the figures:

FIG. 1 shows a perspective view of a device according to the invention for producing a cable harness with a presentation plate, and a plurality of handling elements mounted thereon as well as a cable processing machine and housing assembly machine upstream of the device (presentation plate seen from the front),

FIG. 2 shows the device from FIG. 1 in a perspective view from a different viewing direction (presentation plate seen from the back),

FIG. 3 shows a perspective, enlarged perspective view of handling elements (housing holder, deflector, hold-up means) for the device according to FIG. 1,

FIGS. 4A-4C show the individual handling elements in a side view,

FIG. 5 shows a schematic representation of the main process steps for producing a cable harness,

FIG. 6 shows a more detailed schematic representation of the process steps for producing a cable harness compared to FIG. 5,

FIGS. 7A-7P show a process for producing a new cable harness according to an exemplary embodiment,

FIG. 8 shows a simplified representation of another device for producing a cable harness with two presentation plates and processing robots arranged therebetween,

FIGS. 9A-9B show a positioning head of a positioning system for the device according to FIG. 9 in two different positions, and

FIGS. 10A-10B show an alternative positioning head in two different positions.

### DETAILED DESCRIPTION

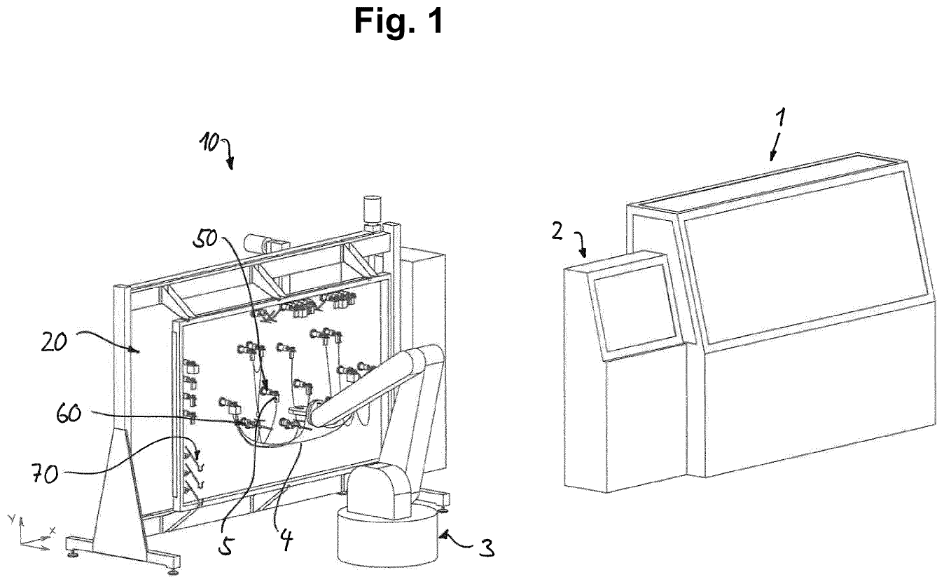

FIG. 1 shows a device 10 for producing a cable harness. Cable harnesses such as those used in automobiles or aircraft, for example, consist of a plurality of cables, wherein the cables are each generally provided with plug housings at their prefabricated cable ends. A cable harness is an arrangement of a plurality of cables or lines in which these are assembled into a structure with an often complex, branched geometry similar to a tree. The respective cable is usually an electrical cable containing, for example, a solid conductor made of copper or aluminum or stranded wire and insulation as a sheath for the conductors. The term “cable” is to be understood broadly below. In this context, a cable is also understood to mean, for example, a cable unit consisting of a plurality of cables or lines of equal length combined into a unit, such as a twisted cable harness.

In FIG. 1, a cable processing machine 1 and a housing assembly machine 2 are arranged upstream of the device 10. The cable processing machine 1 can comprise a stripping station for cutting to length and stripping the cable, one or more crimping stations for applying crimp contacts to the stripped cable ends and, where necessary, one or more grommet stations. In the housing assembly machine 2, connector housings are assembled with prefabricated cable ends of the cables from the cable processing machine 1.

After wiring, cable harnesses must be prepared for their intended use so that they can then be installed in the intended apparatuses, such as automobiles. The cables required for the respective cable harness, which were assembled in the cable processing machine 1 and housing assembly machine 2, are assembled into a tree-like structure by means of the device 10 described in detail below. In so doing, branches and nodes must be secured using suitable securing means (e.g. spot tapes or cable ties). The cable harness may need to be provided with additional protection, either completely or in regions (e.g. by taping with resistant adhesive tape). The device 10 could of course also be a stand-alone machine without the upstream machines 1 and 2. In this case, the necessary cables are delivered pre-assembled.

The device 10 for producing a cable harness comprises a vertical presentation plate 20 on which cables of the cable harness can be arranged on a front side of the presentation plate 20. The cables designated by 4, which are already assembled and equipped with housings 5, are arranged in an intermediate position shown in FIG. 1 in the form of more or less freely hanging loops on the vertical presentation plate 20. The housings 5 of the cables 4 are held by housing holders 50. The cables 4 continue to be acted upon by deflectors 60. These deflectors 60 have the purpose of redirecting the course of cables 4. In the intermediate position according to FIG. 1, a total of four deflectors 60 are present in the not yet completed cable harness, with two such deflectors 60 being grouped in pairs. The housing holders 50 and deflectors 60 form two types of handling elements. In FIG. 1, a third type of handling element can be seen, namely the hold-up means designated 70. These hold-up means 70 are in waiting position in a parking zone. If necessary, the hold-up means 70 can be moved to the cable harness by a positioning system described in detail below and accordingly inserted there. In addition to the hold-up means 70, further handling elements 50, 60 are located in parking zones and wait until they are used for the production of a cable harness.

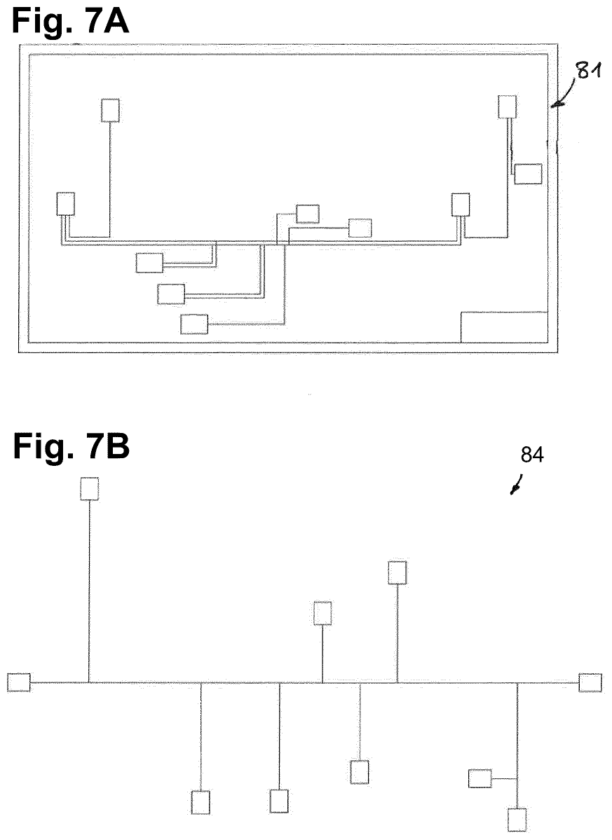

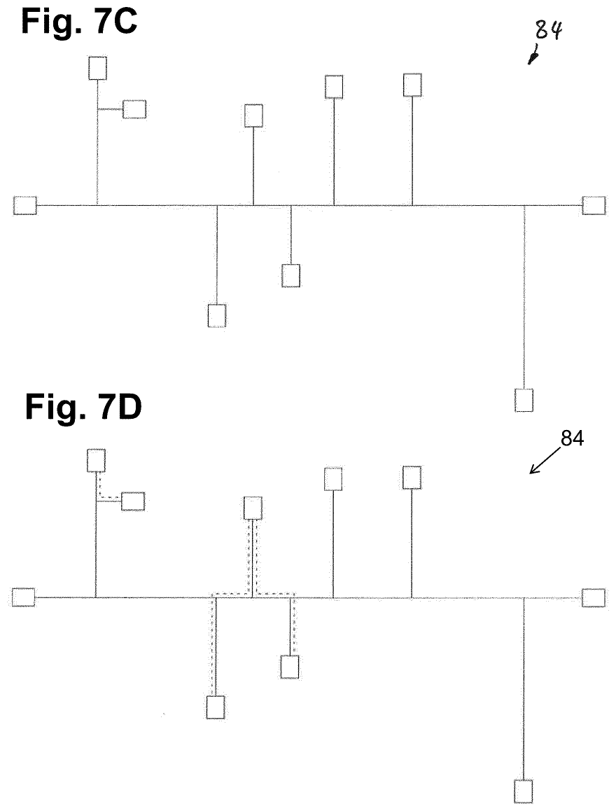

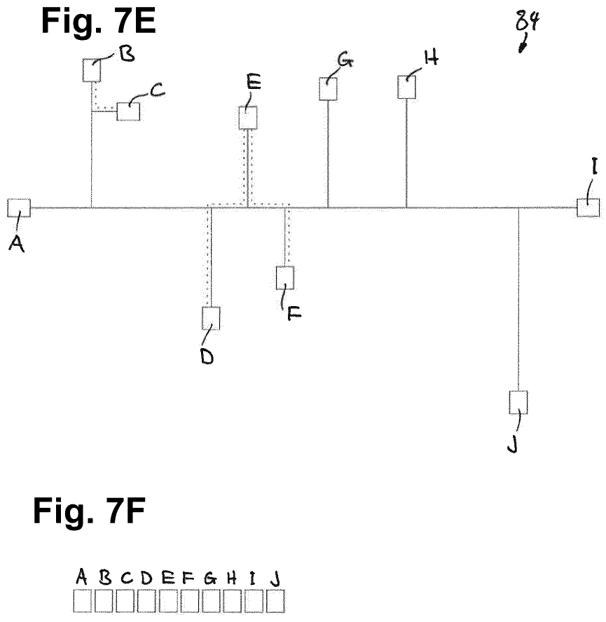

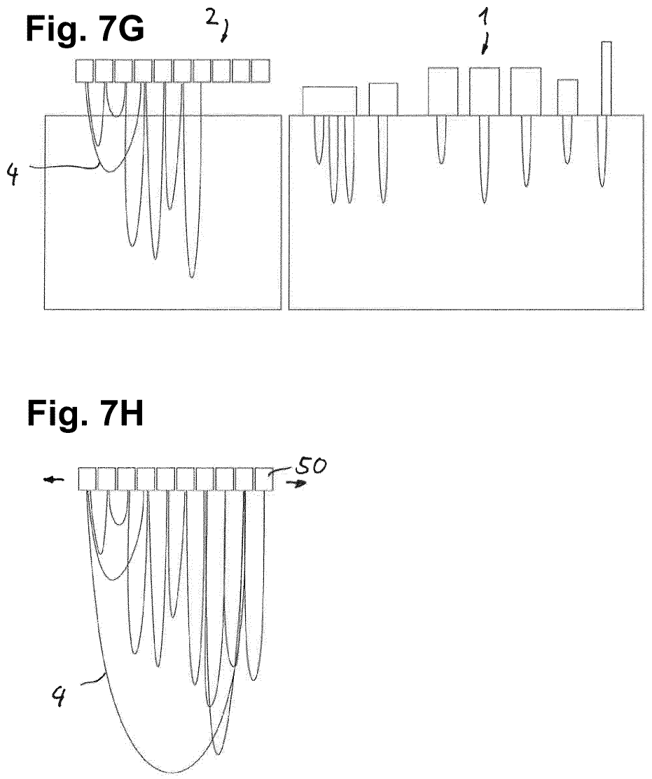

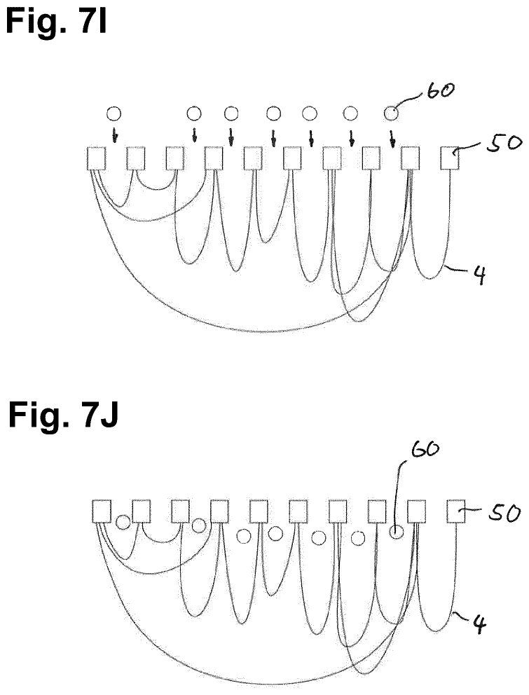

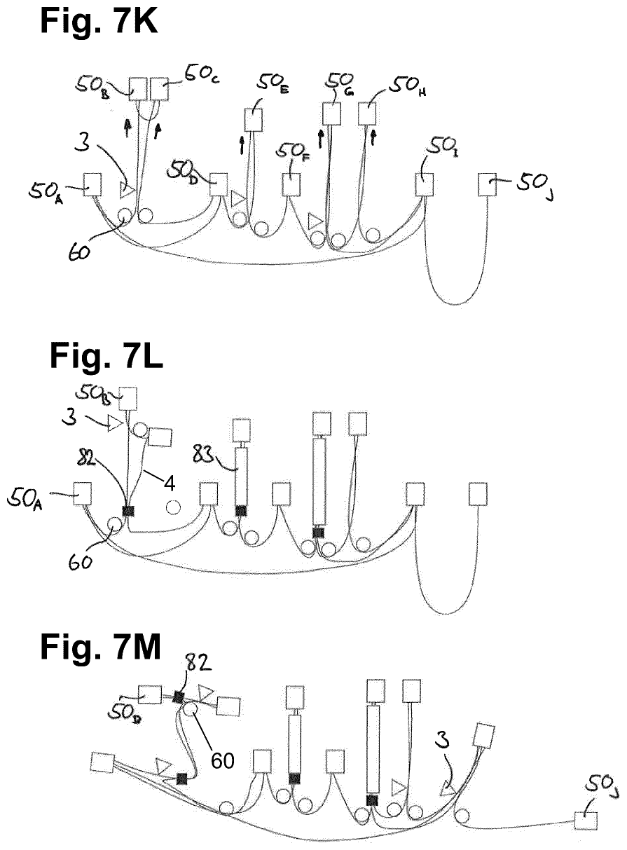

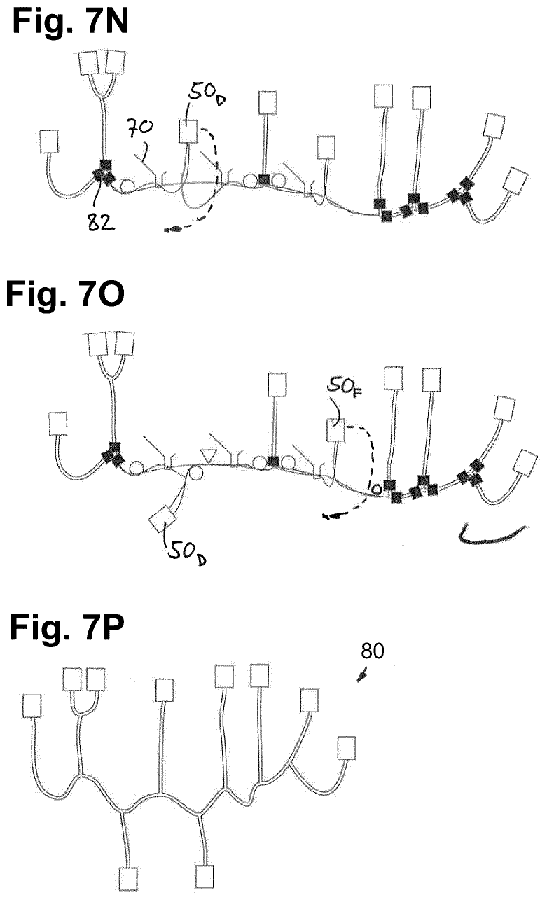

The device 10 further comprises a processing robot 3, with the aid of which securing means can be attached to the cables 4 for fixing and securing at points or sections. With the processing robot 3, for example, spot tapes can be applied. Such a spot tape can be seen in FIGS. 7L, 7M and 7N and is designated 82. The processing robot 3 is designed as an articulated arm robot in the present case. The articulated arm robot can be firmly connected to the floor or designed to move autonomously on the floor.

In the present exemplary embodiment, the handling elements 50, 60, 70 are magnetically attached to the presentation plate 20 and are designed such that they can be moved in all directions of the plane defined by the presentation plate 20. The Cartesian coordinate system shown in FIG. 1 and in subsequent figures is used to assist in understanding the directions and major motions of the components of the device 10. The mentioned plane is plane-parallel to the plane defined by the x and y axes. The handling elements 50, 60, 70 can be moved freely in the x and y directions.

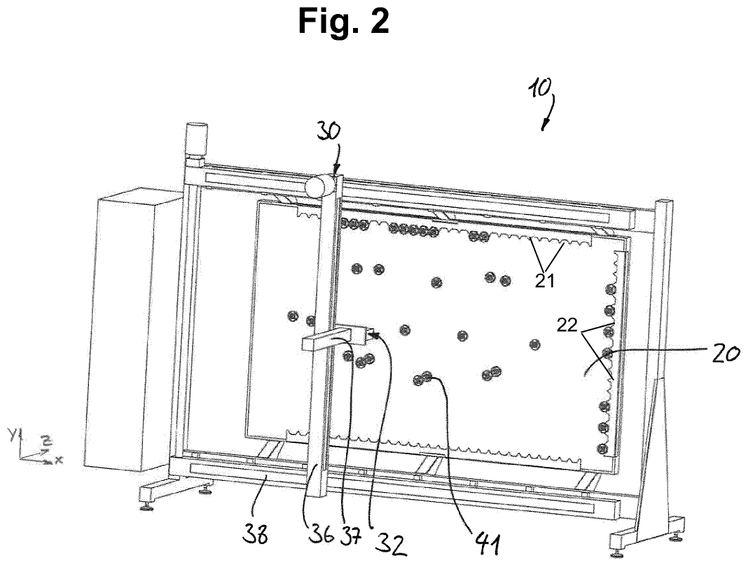

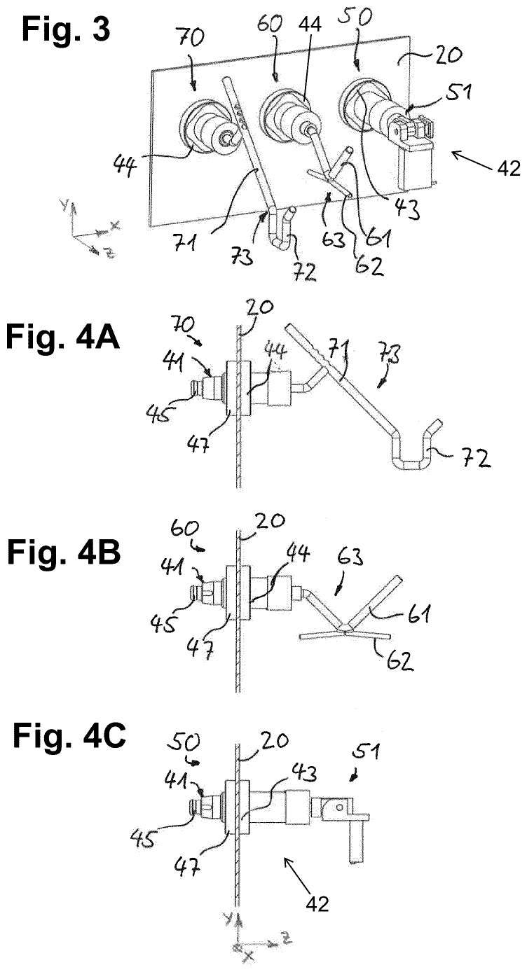

The presentation plate 20 is made of a non-ferromagnetic material. Each of the handling elements 50, 60, 70 comprises a front-side handling part and a rear-side moving part, wherein the handling part and the moving part are each equipped with a permanent magnet for magnetic attachment to the presentation plate so that the permanent magnets attract each other. For this purpose, the permanent magnets are arranged and oriented relative to each other in such a way that unlike poles are opposite each other, whereby the permanent magnets attract each other. One permanent magnet can be provided for each part (handling part, moving part); however, a plurality of permanent magnets could be advantageous for each part. FIG. 2 shows the device 10 with a rear view of the presentation plate 20. Here, the moving parts are visible and marked by 41. In the present case, the moving parts 41 are designed substantially identically for all types of handling elements (regarding handling parts, reference is made to the following FIGS. 3 and 4A-4C).

The moving parts 41 are responsible for the movement of the handling elements 50, 60, 70. To move the handling elements into the desired position, the device 10 has a positioning system 30. The positioning system 30 integrated in the presentation plate 20 is in the present case formed by a gantry robot. The positioning system 30 or the gantry robot has a beam-like gantry carriage 36 that can be moved back and forth in the x-direction along linear guides 38, and a second carriage 37 that can be moved back and forth in the y-direction transversely to the x-direction along the gantry carriage and is equipped with a positioning head 32. The positioning head 32 of the gantry robot forms, so to speak, the interface to the handling element. The positioning head 32 can grasp the handling element via coupling means and bring it to the desired location through the controlled movement of the gantry robot. For this purpose, the positioning head 32 has a coupling part (not shown here) which can be brought into engagement with a coupling part of the handling element for the movement. The respective coupling part of the handling elements is designated 45 in FIGS. 4A-4C.

In the present exemplary embodiment, the presentation plate 20 has parking zones arranged at the top and bottom as well as on a vertical side at the edge with a plurality of parking bays 21, 22 arranged next to one another for parking individual handling elements. The parking bays 21, 22 of the parking zones are formed on the rear side of the presentation plate 20 by receptacles for the main body 47 of the moving parts of the handling elements, wherein the receptacles are formed by indentations and are designed to be complementary to the main body. The respective main body 47 of the handling elements has a circular base area in cross-section; accordingly, the parking bay 21, 22 has a receptacle forming a circular arc.

FIG. 3 shows the three different types of handling elements: housing holder 50, deflector 60 and hold-up means 70. The handling elements differ substantially in the different design of the front-side handling part; the rear-side moving parts 41 are clearly designed approximately the same for all handling elements. The handling part 42 of the housing holder 50 has a handling head 51 which is freely rotatably connected to a main body 43. The housing holder 50 has means for temporarily holding the housing, for example in the present case a housing receptacle into which the housing 5 can be inserted for secure holding. The handling part of the deflector 60 has a handling head 63 with a hook 61. The handling part of the hold-up means 70 has a handling head 73 with a U-shaped cable receiving portion 72 in which cables are collected and held loosely together, wherein the cable receiving section 72 for holding up is further away from the presentation plate 20.

The handling part of the deflector 60 has a handling head 63 connected to a main body 44 which is freely rotatable with the main body 44. When the deflector is attached to the presentation plate 20, the axis of rotation runs with respect to the normal direction (z-direction) defined by the presentation plate 20. The handling head 63 of the deflector 60 is designed such that when the deflector 60 is mounted on the presentation plate 20, it remains in its vertically aligned basic position due to gravity. The same also applies to the hold-up means 70. The hold-up means 70 also has a handling head 73 connected to a main body 44 which is freely rotatably connected to the main body 44. The handling head 73 of the hold-up means 70 is designed such that when the hold-up means 70 is mounted on the presentation plate 20, it remains in its vertically aligned basic position due to gravity. However, the handling head 51 of the housing holder 50 could also be rigidly connected to the associated main body 43, in which case it is advantageous that the main body 43 and the handling head 51 can be rotated from the rear in order to be able to adjust the angular alignment or orientation of the housing to the cable. The positioning system can actively specify the angular orientation of the housing holder by rotation. For this purpose, it may be advantageous if the housing holder 50 has four pairs of magnets, preferably at least two pairs of magnets, in order to be able to transmit the rotational movement from the moving part to the handling part.

Design details for the structure of the handling elements can be taken from FIGS. 4A-4C. FIG. 4A shows that the handling head 73 of the hold-up means 70 comprises a flank section 71 which runs obliquely, in this case by way of example by 45° to the horizontal, and the cable receiving section 72 adjoining the flank section 71 which is U-shaped in side view. The hold-up means 70 can hold up cables in the cable receiving section 72 and thus increase their distance from the presentation plate 20 so that other cables can be passed under the held up cables. The flank section 71 serves as a kind of threading aid. When inserting the hold-up means 70 into the cables to be lifted, the cables to be lifted are first pushed up along the flank section 71 until they finally land in the cable receiving section 72.

The deflector 60 shown in FIG. 4B for deflecting the course of cables has a handling head 63 with an open hook 61 which, in a side view, has a V-shape. In the area of the apex of the hook, a guide rod 62 is arranged on the hook 61. The hook 61 and the guide rod 62 form a horizontal “K” in side view. The open hook 61 allows cables and cable harnesses to be easily collected, while the guide rod 62 prevents cables from slipping under the hook. Since the deflection point defined by the hook 61 is advantageously positioned outside the standing surface of the main body 44, it is also possible to fix difficult deflection situations such as a T-junction by means of two deflectors at a branching point.

The previously described concept of the device 1 for producing a cable harness comprising a presentation plate 20 and handling elements magnetically attached thereto could, as an alternative to the preferred embodiment shown here, also be advantageous for devices for producing cable harnesses, in which devices the presentation plate 20 is aligned in an inclined position or inclined at an angle of inclination relative to the horizontal. The device 1 could even have a horizontal presentation plate. In the latter case, the front of the presentation plate would correspond to a top side of the presentation plate. The handling elements can also be constructed in two parts, with the handling part being assigned to the top side and the moving part to the underside opposite the top side (as the rear side) of the horizontal presentation plate.

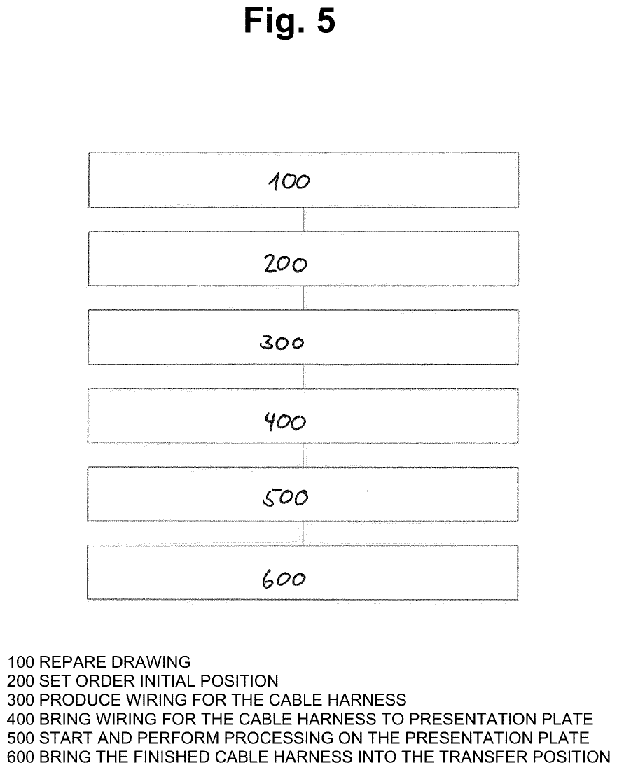

FIG. 5 shows a rough overview of how a cable harness for an automobile, for example, can be produced. Of course, this method can also be used to create a cable harness for another device intended for this purpose. The individual blocks represent, in a very simplified way, the following main process steps:
100 prepare drawing;
200 set order;
300 produce wiring for the cable harness;
400 bring wiring for the cable harness to presentation plate;
500 start and perform processing on the presentation plate; and
600 bring the finished cable harness into the transfer position.

The electrical and electronic requirements of the automobile dictate what the desired cable harness should look like. For this cable harness, a technical drawing for the cable harness is first provided and prepared in the first cited step 100. The technical drawing then forms the basis for the industrial or mass production of the cable harnesses. Based on the technical drawing, among other things, an optimal sequence can be determined in which the wiring for the cable harness should initially be presented on the presentation board in an initial position (step 200).

Based on the technical drawing, the cables are unwound and assembled with the correct cable lengths. This occurs in step 300. The wiring for the cable harness is placed on the presentation board, with the cables being lined up according to the specifications from step 200 (step 400). In step 500, the cables and in particular the cable ends are formed into a tree structure according to the technical drawing, whereby cables are secured and fixed, for example, with spot tapes, clips or bandages. After completion of step 500, the completed cable harness is finally brought into a transfer position in which state the cable assembly can be transported to the automobile for installation. From the transfer position, an operator or another robot can take the cable harness.

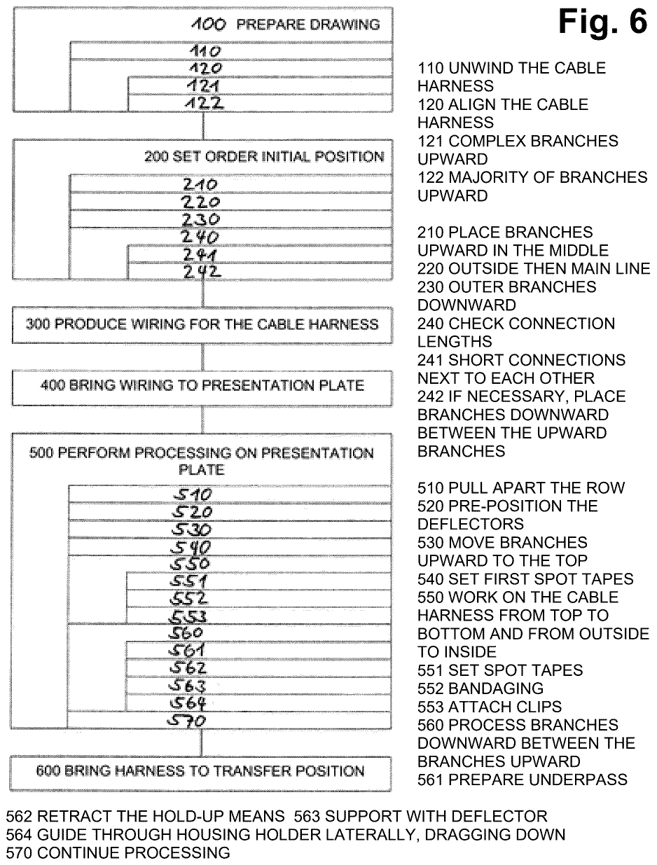

Details for an exemplary design of the previously presented cable harness development process can be seen in FIG. 6. The individual blocks represent the simplified following process steps:
100 prepare drawing,
110 unwind the cable harness,
120 align the cable harness,
121 complex branches upward,
122 majority of branches upward;
200 set order,
210 place branches upward in the middle,
220 outside then main line,
230 outer branches downward,
240 check connection lengths,
241 short connections next to each other,
242 if necessary, place branches downward between the upward branches;
300 produce wired cable harness;
400 place wired cable harness on presentation plate;
500 start processing,
510 pull apart the row,
520 pre-position the deflectors,
530 move branches upward to the top,
540 set first spot tapes,
550 work on the cable harness from top to bottom and from outside to inside,
551 set spot tapes,
552 bandaging,
553 attach clips,
560 process branches downward between the branches upward,
561 prepare underpass,
562 retract the hold-up means,
563 support with deflector,
564 guide through housing holder laterally, dragging down,
570 continue processing;
600 place the finished cable harness in the transfer position.

All and at least some of the above-mentioned process steps can be carried out with the arrangement comprising the device 10 as well as the cable processing machine 1 and the housing assembly machine 2. The preparation of the technical drawing for the cable harness (step 100) usually takes place at another location, for example using a computer. The determination of the sequence (step 200) can be carried out automatically by means of suitable software on a computer that belongs to the arrangement and in particular to the device 1. However, the order could also be determined remotely.

The method for producing a cable harness using the device 10 previously described with reference to FIGS. 1 to 4C comprises the following key steps:
providing the vertical presentation plate 20;
arranging cables 4 equipped with housings 5 and required for the cable harness on the presentation plate 20 using housing holders 50, wherein the housing holders 50 are arranged in a predetermined order in the horizontal direction x;
inserting deflectors 60 between the housing holders 50, wherein the housing holders 50 are first moved, if necessary, in such a way that the distance between the housing holders 50 is increased in order to enable the deflectors 60 to insert smoothly between the housing holders 50;
moving a portion of housing holders 50 from the housing holder row, preferably moving upward those housing holders 50 which are assigned to upper branches of the cable harness;
attaching securing means from the group of spot tapes 82, clips or bandages 83 for fixing and securing upwardly moved cables 4 at points or sections by means of the processing robot 3.

Further details on the method for producing the cable harness using the device 1 can be seen in FIGS. 7A-7P with reference to a specific exemplary embodiment. FIG. 7A shows a technical drawing 81 for a cable harness. Such a technical drawing shows the wiring plan for the cable harness. FIG. 7B substantially corresponds to an abstracted version of the technical drawing 81 of FIG. 7A, in particular not all connections or cables are shown. The virtual model of the cable harness is designated 84.

Since the present cable harness 84 has a plurality of branches that go downward, it is rotated by 180°. FIG. 7C shows the simplified cable harness 84 after this rotation. If the cables are arranged on the presentation plate in such a way that the lower branches are in the minority compared to the upper branches, it can be ensured that as few underpasses as possible have to be made using hold-up means, which makes the method considerably faster and easier to carry out.

Now the order of the housings and thus the housing holders that hold them can be determined. When determining the order, it must be considered how long the respective cables are. In FIG. 7D, which is based on FIG. 7C, additional critical cables with particularly short cable lengths are shown by dashed lines. With regard to short cables, there is less freedom in positioning them or their housings, as the space for laying U-shaped cable loops is limited.

In FIG. 7E, the housings of the cables for the cable harness are designated «A» to «J». The order of the housings (and thus the corresponding housing holders) is determined by the following factors:
housings that are assigned to upwardly oriented branches of the cable harness are positioned in the middle of the row;
housings that are assigned to the main strand of the cable harness are positioned at the outside of the row;
   housings that are assigned to downward-oriented branches of the cable harness are positioned at the outside of the row;
   when positioning the housings in the row, the respective cable lengths of the cables are taken into account, wherein the housings that are each assigned to common cables with short cable lengths are preferably positioned directly next to each other. The sequence A to J is accordingly defined as follows in the present embodiment: The housings B, C, E, G, H, which are assigned to upwardly oriented branches of the cable harness, are initially positioned in the middle of the row. Housings A and I, which are assigned to the main strand of the cable harness, are positioned on the outside of the row. Housings D, F, J, which are assigned to downward-oriented branches of the cable harness, should be arranged on the outside of housings A and I of the main strand. However, the respective cable lengths and in particular the particularly short cables must be taken into account. Therefore, the two housings B, C, which are connected to each other by a very short cable, must be positioned directly next to each other. According to the above rule regarding downward-oriented branches, the housings D and F should actually be positioned further out. However, since the cables D-E and E-F are obviously short, this must be taken into account, which is why D must be positioned next to E on one side and F on the other side. Finally, the downward-oriented branch with the housing J provided at the end of the branch must be noted. Since, as mentioned at the beginning, as few underpasses as possible should be made using hold-up means, the housing J is positioned on the outside of the row, in this case to the right of housing I.

In FIG. 7F, the housings are shown arranged side by side in the sequence A, B, C, D, E, F, G, H, I, J. This substantially corresponds to the arrangement of the housing holders 50 as they are arranged on the vertical presentation plate. This arrangement is shown in FIG. 7H. The housing holders 50 are arranged in the predetermined order in the horizontal direction (x).

FIG. 7G shows a cable processing machine 1 and a housing assembly machine 2 in which the necessary cables for the cable harness are cut to length, assembled and fitted with housings 5. The respective cables 4 are already present in these devices 1 and 2 as downward hanging cable loops in U-shape. From the housing assembly machine 2, the cables are brought manually or with appropriate transfer means (not shown here) to the vertical presentation plate and arranged there as shown in FIG. 7H. The housings can be completely lined up to save space and simplify handling for transfer to the presentation plate. The housings could also be divided into blocks. In the initial position shown in FIG. 7H, a rough form for the cable harness is presented on the presentation plate, in which it has been brought into a U-shape with a plurality of U-shaped downward-hanging cables 4, forming cable loops.

The housing holders 50 are then moved such that the distance between the housing holders 50 is increased (FIG. 7H). After the pulling apart is complete, the situation shown in FIG. 7I arises. One of the purposes of pulling apart is to reduce the depth of the cable loops. This brings the cable loops under better control for the subsequent method step (less swinging, less fanning out) and creates space to place deflectors between the housing holders. Furthermore, it can be seen from FIG. 7I that all housing holders 50 and, more precisely, all handling heads of the housing holders, which handling heads are freely rotatably connected to the associated main bodies, are in a vertically aligned basic position.

After being pulled apart, deflectors 60, symbolically represented as circles, can move smoothly between the housing holders 50. This step is shown in FIG. 7J. Now the housing holders 50 are moved upward, which are assigned to the upper branches of the cable harness. For better understanding, the housing holders 50 are indexed, wherein the respective index corresponds to the housing according to the sequence of FIG. 7F. Deflectors 60 ensure the desired deflection of the cables 4. The direction of movement of the housing holders 50_{B}, 50_{C}, 50_{E}, 50_{G}, 50_{H} are indicated by arrows. This corresponding position is shown in FIG. 7K.

In FIG. 7L, the first securing means have already been applied. 82 denotes spot tapes (and is indicated by small blackened squares) with which cables 4 are fixed point by point. Further securing means are bandages 83 which wrap and thus secure longer sections of cables. When bandaging, it is sometimes also necessary to place the branch points in a hyperextended position. The securing means 82, 83 are attached by means of processing robots. The respective processing robot(s) 3 are symbolically represented by small triangles. It is advantageous to use a plurality of processing robots 3 so that securing means can be applied at different locations on the cable harness at the same time.

The desired processing points of the cable harness are advantageously presented to the processing robots 3 in an overstretched position and not in the final angled position in order to enable the accessibility of the respective processing point.

FIG. 7L also shows that during or after the step in which the branches are moved upward by moving the housing holders 50_{B}, 50_{C}, 50_{E}, 50_{G}, 50_{H} and the deflectors 60 are positioned so that the first spot tapes (at the branch points to the main strand) are set, the branching points of the upward branches are also already prepared (here, for example, between B and C).

As can be seen from FIG. 7M, further movements of the handling elements 50, 60 then take place. The cable harness is pulled apart, and the housing holders are removed from each other. For example, the housing holder 50_{J} is moved further outward to the right in a lateral dragging motion. By means of processing robot 3, further spot tapes 82 are applied, after which the position shown in FIG. 7N is obtained. The structure of the cable harness is already clearly defined and is distinguished by a few freely swinging loops, which makes the use of the hold-up means much easier.

From FIG. 7M, it can then be further seen that at least in some areas, the housing holders are moved in such a way that, in combination with the deflectors, an extension results, whereby the freely rotatably mounted handling heads of the housing holders are aligned in a position other than the vertical basic position. This can be seen, for example, with the housing holder 50, which, or more precisely the handling head of which, is now aligned horizontally.

Now the housing holder 50_{D}, since it is assigned to a downward-oriented branch of the cable harness, can be moved downward. For this purpose, the hold-up means 70 are inserted into the main strand, as also shown in FIG. 7N. It should be ensured that the main strand sags sufficiently to allow deflection by the hold-up means 70. When the hold-up means is inserted into the main cable to be lifted, it is first pushed up along the flank section and finally brought into the U-shaped cable receiving section at a higher level than the presentation plate. In other words, the cables combined in the form of the cable harness are held up by the hold-up means 70, and thus the distance to the presentation plate is increased in order to allow cables to be passed under the held up cables. The underpass is now prepared, and the branch in question can pass under the cable harness. Thus, the housing holder 50_{D} can be moved downward without interference. This results in the position shown in FIG. 7O. When moving the housing holder 50_{D} it is advantageous that the movement is carried out as a lateral dragging. The housing holder 50_{D} is not moved in a straight line from the position shown in FIG. 7N to FIG. 7O, but the travel curve of the housing holder 50_{D} can have a curved course. The travel curve is indicated by a dashed line in FIG. 7N. The lateral dragging, in particular when supported by one or more deflectors 60, prevents kinking of wire connections of the cables 4 and uncontrolled or other undesirable behavior of the cable loops. The lateral dragging advantageously takes place in a first phase of the respective movement of the housing holder in question. This is particularly advantageous for housing holders that have to be moved downward and whose movement should always begin with lateral dragging.

After that, the housing holder 50_{F} must be moved downward. The corresponding procedure takes place approximately analogous to that for the first lower branch or the housing holder 50_{D}. Finally, the desired cable harness 80 is created.

FIG. 7P shows this cable harness 80, wherein it is slightly compressed in the horizontal direction in addition to creating a transfer position, since in this compressed form, the cable harness is overall easier to handle for further use.

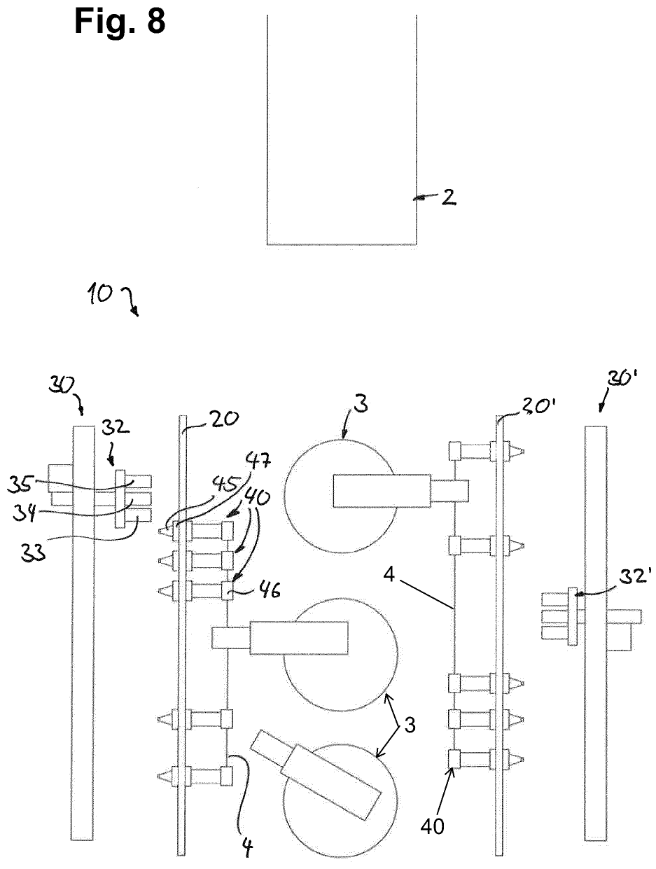

As FIG. 8 shows, the device 10 can have two presentation plates 20, 20′. In the present case, three processing robots 3 are provided between the two presentation plates 20, 20′, by means of which securing means can be attached to the cables 4 on both sides for fixing and securing at points or sections. The handling elements for handling the cables 4 of the cable harness are designated in a general manner with 40 in this case. These handling elements 40 can be the previously mentioned and described housing holders, deflectors or hold-up means. FIG. 8 further shows that the positioning head 32, 32′ of the positioning system 30, 30′ can have a plurality of coupling parts. In the present case, the positioning head 32, 32′ has, for example, three coupling parts 33, 34, 35. Three handling elements 40 can be moved via the coupling parts 33, 34, 35. The coupling parts corresponding to the coupling parts 33, 34, 35 and assigned to the handling elements 40 are designated by 45, and the handling heads generally by 46.

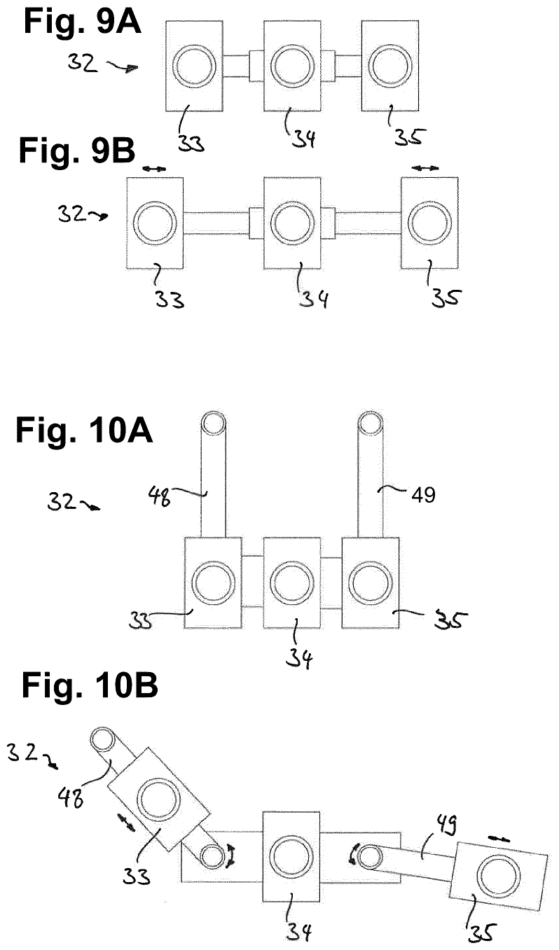

FIGS. 9A and 9B show such a variant of a positioning head 32 with a plurality of coupling parts 33, 34, 35. The coupling parts 33, 34, 35 can be moved linearly on a common axis, whereby the distance between the coupling parts 33, 34, 35 and thus also the distance of handling elements (not shown here) can be adjusted by an adjustment mechanism 48, 49.

FIGS. 10A and 10B show a further variant of a positioning head 32 with a plurality of coupling parts 33, 34, 35, wherein movements with a plurality of degrees of freedom are possible with this positioning head. In the present case, the positioning head 32 has an adjustment mechanism by means of which the two outer coupling parts 33 and 35 can be pivoted and displaced back and forth relative to an axis of pivoting links 48, 49.

In accordance with the provisions of the patent statutes, the present invention has been described in what is considered to represent its preferred embodiment. However, it should be noted that the invention can be practiced otherwise than as specifically illustrated and described without departing from its spirit or scope.

1-22. (canceled)

23. A device for producing a cable harness, the device comprising:
a presentation plate extending in a plane, the presentation plate having a front side adapted for arranging cables of the cable harness on the front side and having an opposite rear side;
a plurality of handling elements, each of the handling elements adapted to handle at least one of the cables; and
wherein the handling elements are movably attached to the presentation plate and are movable in the plane of the presentation plate.

24. The device according to claim 23 wherein the presentation plate is formed of a non-ferromagnetic material, the handling elements each include a handling part adapted to attach to the front side and a moving part adapted to attach to the rear side, one of the handling part and the moving part of each of the handling elements has a first permanent magnet that magnetically attaches to the presentation plate, and another one of the handling part and the moving part of each of the handling elements has ferromagnetic material or a second permanent magnet, the first permanent magnet and the second permanent magnet having opposite poles that attract each other.

25. The device according to claim 24 wherein the moving part has a coupling part adjoining a main body, the coupling part adapted to move the moving part in the plane of the presentation plate.

26. The device according to claim 24 wherein the handling part has a handling head adjoining a main body, the handling head being connected to the main body for free rotation in a direction normal to the plane of the presentation plate.

27. The device according to claim 26 wherein when the plane of the presentation plate extends in a vertical direction, and the handling part is attached to the front side, the handling head is vertically aligned in a basic basic position due to gravity.

28. The device according to claim 23 wherein the handling elements include at least one of: a housing holder adapted to hold a housing attached to one of the cables, and/or a deflector adapted to deflect a course of at least one of the cables; and/or a hold-up means adapted to hold at least one of the cables further from the front side than another of the cables.

29. The device according to claim 28 wherein the deflector has a handling head including an open hook having a V-shape and a guide element arranged on the hook.

30. The device according to claim 28 wherein the hold-up means has a handling head including an obliquely extending flank section and a cable receiving portion adjoining the flank section, the cable receiving portion being U-shaped.

31. The device according to claim 23 wherein the presentation plate has at least one parking zone including a plurality of parking bays arranged next to one another, each of the parking bays adapted to park one of the handling elements.

32. The device according to claim 31 wherein each of the handling elements has a main body base area circular in cross-section, and each of the parking bays has a receptacle forming a circular arc being complementary to the main body base area.

33. The device according to claim 23 including a positioning system adapted to move the handling elements into desired positions on the front surface, the positioning system being a gantry robot movably attached to the presentation plate at the front surface.

34. The device according to claim 33 wherein gantry robot of the positioning system includes a positioning head having a plurality of coupling parts, the coupling parts each adapted operatively connect with one of the handling elements, the coupling parts adapted to move separately relative to one another relative to the plane of the presentation plate.

35. The device according to claim 34 wherein the coupling parts are arranged in a row at a distance from one another, which distance can be changed by an adjustment mechanism moving at least one of the coupling parts along the row or pivoting the at least one coupling part relative to another of the coupling parts.

36. The device according to claim 23 including a first and a second of the presentation plate positioned with the front sides facing, a processing robot positioned between the front sides of the presentation plates, the processing robot adapted to attach securing means to the cables.

37. A method for producing a cable harness, the method comprising steps of:
providing the presentation plate according to claim 23 with the plane oriented in a vertical direction;
arranging a plurality of cables equipped with housings, the cables being required to produce the cable harness, and holding each of the housings on the presentation plate with an associated housing holder being one of the plurality of handling elements, wherein the housing holders are positioned on the front surface of the presentation plate in a predetermined order in a housing holder row extending in a horizontal direction;
inserting deflectors between adjacent ones of the housing holders;
moving from the housing holder row at least ones of the housing holders that are holding the housings of the cables forming upper branches of the cable harness; and
attaching a plurality of securing means to selected ones of the cables at points or sections by a processing robot.

38. The method according to claim 37 including attaching the securing means one after another, and after at least one of the securing means is attached, moving one of the housing holders in the horizontal direction.

39. The method according to claim 37 including moving downward ones of the housing holders holding the housings of the cables forming lower branches of the cable harness after the upper branches of the cable harness are completed.

40. The method according to claim 39 including lifting ones of the cables away from the front surface by hold-up means enabling ones of the housing holders to move downward under the lifted cables to form the lower branches.

41. The method according to claim 37 including determining the predetermined order in the housing holder row according to factors of:
positioning in a middle of the housing holders row ones of the housing holders assigned to the upwardly oriented branches of the cable harness;
positioning at outsides of the housing holder row ones of the housing holders assigned to a main strand of the cable harness;
positioning farther at the outsides of the housing holder row ones of the housing holders assigned to downwardly oriented branches of the cable harness; and
positioning ones of the housing holders assigned to shorter ones of the cables with similar cable lengths near or directly next to each other.
